(19) United States
(12) Patent Application Publication
(10) Pub. No.: US 2009/0320284 A1
(43) Pub. Date: Dec. 31, 2009

(54) Method of Forming Injection Hole for Injector

(75) Inventors: Takeshi Takahashi, Osaka (JP); Terumitsu Takahata, Osaka (JP); Satomi Ukai, Hyogo (JP); Gou Asai, Osaka (JP); Kouji Shimizu, Osaka (JP); Takao Kawabe, Osaka (JP); Yukihiro Shinohara, Aichi (JP); Tomoyuki Tsuda, Aichi (JP)

Correspondence Address: STERNE, KESSLER, GOLDSTEIN & FOX P.L.L.C., 1100 NEW YORK AVENUE, N.W., WASHINGTON, DC, 20005, US

(73) Assignees: Yanmar Co., Ltd., Osaka-shi, Odaka (JP); Denso Corporation, Kariya-city, Aichi (JP)

(21) Appl. No.: 12/374,907

(22) PCT Filed: Jun. 5, 2007
(86) PCT No.: PCT/JP2007/061385

§ 371 Date: Apr. 10, 2009

(30) Foreign Application Priority Data
Jul. 25, 2006 (JP) 2006-202573

(51) Int. Cl. B21K 1/22; B23B 47/28

(52) U.S. Cl. 29/888.4; 408/1 R

(57) ABSTRACT

In a method for boring injection holes of an injector 1 having a plurality of intersections between an axis line of the injector 1 and the axes of the injection holes 10a bored in the injector 1, or so-called a group of injection holes 10, flat sections 10c, 10d, which are perpendicular to the injection holes 10a and include apertures of the injection holes 10a, are formed on boring portions of injection holes 10a. The boring portions are provided with recessed portions 10b and the recessed portions 10b are formed at the bottom thereof with flat sections 10c. Alternatively, the flat sections 10c, 10d are formed by cutting the boring portions, or by forging them.

### BACKGROUND OF THE INVENTION

1. Field of the Invention

The present invention relates to a technique for an injector of an engine equipped with a common-rail fuel injection device, more specifically, a method for boring injection holes of the injector having so-called a group of injection holes.

2. Related Art

Conventionally, there is a well-known common-rail fuel injection device provided with a diesel engine. There is also a well-known concrete configuration of an injector injecting fuels supplied from the common-rail.

Moreover, an injector, which has a plurality of intersections between an axis line of the injector and the axes of injection holes bored in a nozzle body of the injector, i.e., which has a group of injection holes, is heretofore known. The injector having a group of injection holes can have smaller injection holes than an injector having the same amount of injection quantity without a group of injection holes. Therefore, it is noted that the injector having a group of injection holes enables injected fuels to be atomized and diffused over a wider range, compared to the injector without a group of injection holes, thereby improving an ignition performance and securing a low combustion noise and good combustion state, even when the engine is cool and low cetane value fuels are used. It is also known that the injector having a group of injection holes is effective as a means for cleaning up an exhaust gas, since it enables total hydrocarbons (THC) and particulate matters (PM) contained in the exhaust gas to be reduced. For example, JP 2006-70802 discloses the above-mentioned technique.

### SUMMARY OF THE INVENTION

However, it is proved from experimental results and the like that processing variations, such as boring positions of the injection holes, relative positions and angles or torsions to a circumferential direction of the respective injection holes, directly affect the exhaust gas property, in the injector having a group of injection holes.

So, the injector having a group of injection holes is required to inhibit the processing variations, such as boring positions of the injection holes, relative positions and angles or torsions to the circumferential direction of the respective injection holes, and to secure a high processing accuracy. Conventionally, as the injection holes are bored on curved surfaces of substantially spherical surfaces by electrical discharging, it is difficult to satisfy a predetermined figure tolerance and secure the processing accuracy in actual production processes, thereby reducing a distributive homogeneity of the injected fuels and causing variations of the exhaust gas property. Consequently, it was difficult to put the injector having a group of injection holes to practical use, due to the above-described problems.

Accordingly, in consideration to the above-discussed problems, it is an object of the present invention to provide a method for boring the injection holes of the injector having a group of injection holes, which is capable of securing the processing accuracy of the injection holes and reducing variations of the exhaust gas property, in actual production processes.

The problem so as to be solved by the present invention is as mentioned above. Next, the means of solving the problem will be described.

In a method for boring injection holes of an injector according to the present invention, a method for boring injection holes of the injector having a plurality of intersections between an axis line of the injector and the axes of the injection holes bored in the injector, comprises a step of forming flat sections, which are perpendicular to the injection holes and include apertures of the injection holes, on the boring portions of the injection holes.

In the method for boring injection holes of the injector according to the present invention, the boring portions are provided with recessed portions and the recessed portions are provided at the bottom thereof with the flat sections.

In the method for boring injection holes of the injector according to the present invention, the flat sections are formed by cutting the boring portions.

In the method for boring injection holes of the injector according to the present invention, the flat sections are formed by forging the boring portions.

The present invention shows the following effects.

In the method for boring injection holes of the injector according to the present invention, a method for boring injection holes of the injector having a plurality of intersections between an axis line of the injector and the axes of the injection holes bored in the injector comprises the step of forming a flat section, which are perpendicular to the injection holes and include apertures of the injection holes in boring portions of the injection holes, thereby decreasing a processing tolerance of the injection holes and reducing variations of the exhaust gas property so as to acquire a stable performance.

In the method for boring injection holes of the injector according to the present invention, recessed portions are formed at the boring portions and the flat sections are formed at the bottom of the recessed portions, thereby easily and accurately forming the flat sections in the actual production processes.

In the method for boring injection holes of the injector according to the present invention, the flat sections are formed by cutting the boring portions, thereby easily and accurately forming the flat sections in the actual production processes.

In the method for boring injection holes of the injector according to the present invention, the flat sections are formed by forging the boring portions, thereby easily and accurately forming the flat sections in the actual production processes.

### BRIEF DESCRIPTION OF THE DRAWINGS

FIG. 1 is a side view of an entire construction of an injector according to an embodiment of the present invention.

FIG. 2 is a side view of a detailed construction of a group of injection holes according to an embodiment of the present invention.

FIG. 3 is a perspective view showing a conventional group of injection holes and boring portions of the group of injection holes.

FIG. 4 is a perspective view showing a group of injection holes and boring portions of the group of injection holes (flat sections) according to the first embodiment.

FIG. 5 is a perspective view showing a group of injection holes and boring portions of the group of injection holes (flat sections) according to the second embodiment.

1 injector

10 a group of injection holes

10a injection hole

10b recessed portion

10c flat section

10d flat section

### DETAILED DESCRIPTION OF THE INVENTION

Next, embodiments of the present invention will be described.

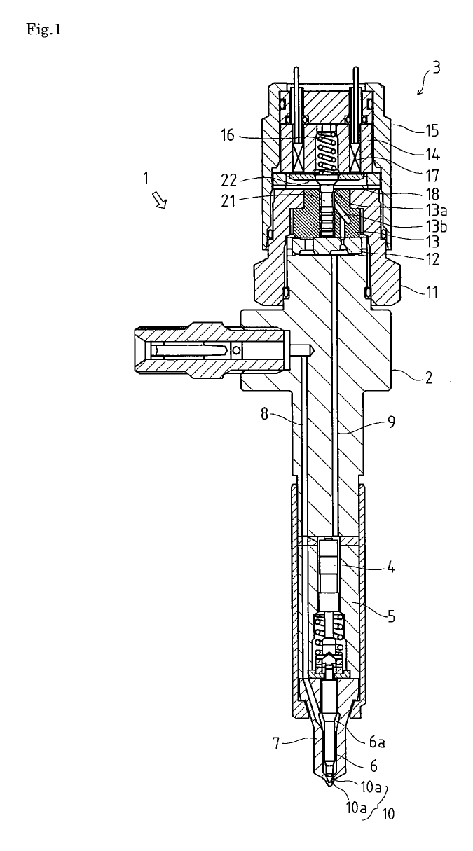

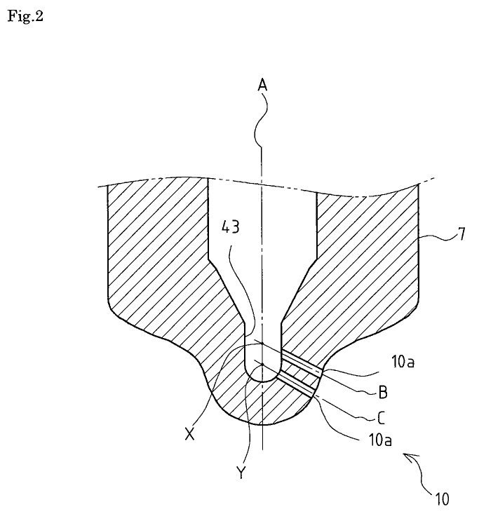

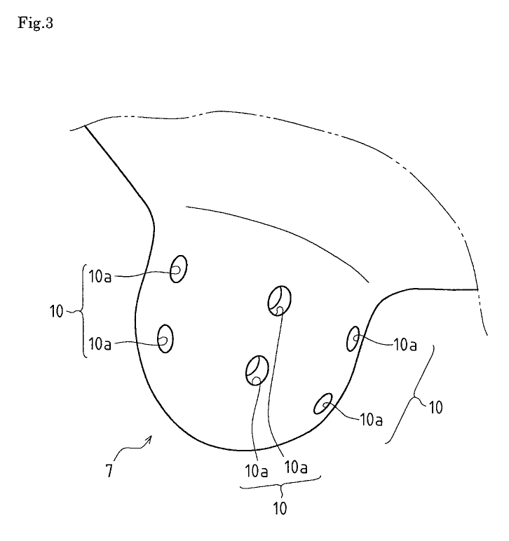

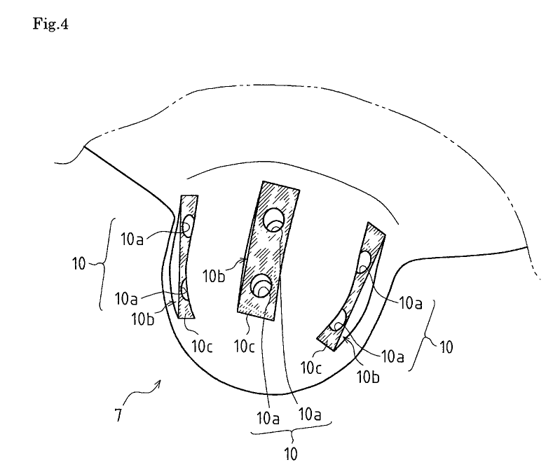

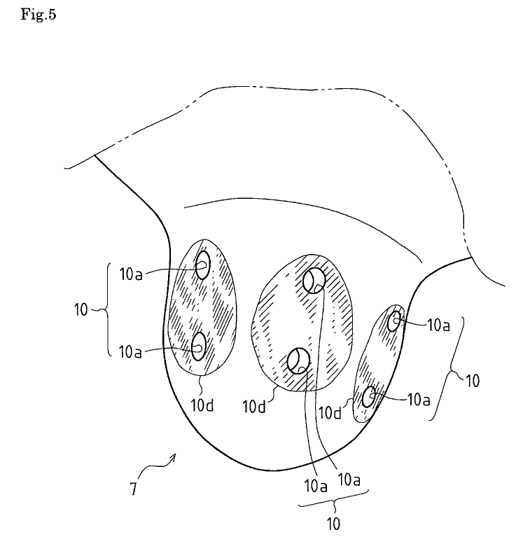

FIG. 1 is a side view of an entire construction of an injector according to an embodiment of the present invention. FIG. 2 is a side view of a detailed construction of a group of injection holes according to an embodiment of the present invention. FIG. 3 is a perspective view showing a conventional group of injection holes and boring portions of the group of injection holes. FIG. 4 is a perspective view showing a group of injection holes and boring portions of the group of injection holes (flat sections) according to the first embodiment. FIG. 5 is a perspective view showing a group of injection holes and boring portions of the group of injection holes (flat sections) according to the second embodiment.

As shown in FIG. 1, an injector 1 includes an injector body 2, a solenoid valve 3, a command piston body 5 and a nozzle body 7. The solenoid valve 3, which is provided on the upper portion of the injector body 2, controls a back pressure of a command piston 4 so as to control a fuel injection. The command piston body 5, which is provided on the lower portion of the injector body 2, is slidably provided therein with the command piston 4. The nozzle body 7, which is provided on the lower portion of the command piston body 5, is slidably provided therein with a needle valve 6. Due to the above construction, the injector 1 is set up to inject high-pressure fuels, which is supplied from a common-rail (not shown) to a fuel supplier 8, through injection holes 10a, 10a provided at the end portion of the nozzle body 7.

As shown FIGS. 1 and 2, in the solenoid valve 3, an orifice plate 12 and a valve sheet 13 are integrated with the injector body 2 by a valve holding member 11, and a cap 15, in which a solenoid core 14 is disposed in the valve holding member 11, is fixed on the injector body 2. An axial valve disc 21 is vertically, slidably provided with the valve sheet 13. The valve disc 21 is constantly biased downwardly by an elastic force of a spring 16 internally provided in a spring chamber 14s of the solenoid core 14, and the valve disc sheet surface 21a is attached to the valve sheet surface 13a of the valve sheet 13, so as to prevent a flowing out of the fuels from a high-pressure oil passage 13b to a low-pressure fuel chamber 18, thereby securing the back pressure of the command piston 4 through a controlling oil passage 9. Accordingly, the command piston 4 is moved downwardly by the back pressure and presses downwardly the needle valve 6, thereby limiting the fuel injection.

An armature 22 is fixed on the upper side of the valve disc 21.

The armature 22 is vertically, movably disposed in the low-pressure fuel chamber 18 formed between the solenoid core 14 and the valve sheet 13.

When a solenoid coil 17 is energized, the armature 22 is moved upwardly with the valve disc 21, the valve disc sheet surface 21a is detached from the valve sheet surface 13a and the fuels in the high-pressure oil passage 13b are flowed out to the low-pressure fuel chamber 18. Accordingly, the high-pressure fuels in the controlling oil passage 9 are flowed out to the low-pressure fuel chamber 18, and the back pressure of the command piston 4 is decreased. Then, the needle valve 6 is lifted by the high-pressure fuels supplied in the nozzle fuel chamber 6a, thereby injecting the fuels.

As described above, the armature 22 is moved in the low-pressure fuel chamber 18 between the solenoid core 14 and the valve sheet 13, thereby limiting the flow of the fuels for the injection control by the valve disc 21 integral with the armature 22, so as to control the fuel injection.

As mentioned above, the entire construction of the injection as a major portion of the present invention was described.

Next, a construction of a group of injection holes according to an embodiment of the present invention will be described with reference to FIG. 2. As shown in FIG. 2, the injector 1 according to an embodiment of the present invention includes so-called a group of injection holes 10.

The group of injection holes 10 is configured to form a plurality of injection holes 10a, 10a, having respective different axis lines to the axis direction, on a plane surface including an axis line of the nozzle body 7 (i.e., an axis line of the injector 1).

In other words, the injection holes 10a, 10a are disposed so that a plurality of intersections (the intersections X and Y) between the axis line (the axis line A) of the nozzle body 7 and the axes (the axis lines B and C) of the injection holes 10a, 10a are present in the axis direction of the nozzle body 7.

Incidentally, in the present embodiment, an example, in which two points of intersections between the axis line of the nozzle body 7 and the axes of the injection holes 10a, 10a are present in the axis direction, is provided without limitation, but three or more points of intersections may be present.

In FIG. 2, the group of injection holes 10 on any cross section are shown, but a plurality of group of injection holes 10 are radially disposed at even intervals centered around the axis line of the nozzle body 7, as an entire construction of the nozzle body 7.

Incidentally, in the present invention, the injection holes 10a are set up to communicate with a sack 43 but not limited to the construction.

As mentioned above, the construction of the group of injection holes according to an embodiment of the present invention was described.

Next, flat sections formed at boring portions of a group of injection holes, according to an embodiment of the present invention, will be described with reference to FIGS. 3 to 5.

As shown in FIG. 3, in the injector having a conventional group of injection holes, the group of injection holes 10 are formed at the spherical end portion of the nozzle body 7.

The injection holes 10a, 10a are bored by an inexpensive machining process (for example, a process by a drill), but a positioning of the end of the drill is difficult by a skidding or an escape of a blade edge of a machine tool, when the outer shape thereof is a curved surface, leading to a displacement of it, whereby it was difficult to secure dimensional tolerances of the injection holes 10a, 10a.

Therefore, embodiments of the present invention capable of easily improving the processing accuracy will be described below.

### FIRST EMBODIMENT

As shown in FIG. 4, the group of injection holes 10 (the injection holes 10a, 10a) is provided at the boring portions thereof with recessed portions 10b, the recessed portions 10b are provided at the bottom thereof with flat sections 10c, and the flat sections 10c are provide with the group of injection holes 10.

The flat sections 10c form planar surfaces perpendicular to the axis lines of the bored injection holes 10a and can be easily formed by the machining such as a cutting or a forging. The dimensional tolerance, such as relative positions/angles of the respective recessed portions 10b, 10b . . . , or the respective flat sections 10c, 10c . . . , can be secured with comparative ease by the machining process.

Thus, the processing accuracy can be improved by boring the injection holes 10a, 10a with a drilling hole processing, on the flat sections 10c where the dimensional tolerance has been secured.

Incidentally, in the present embodiment, an example, in which the group of injection holes 10 (the injection holes 10a, 10a) is bored with a drilling hole processing, on the respective flat sections 10c, 10c . . . , is provided without limitation, but the group of injection holes 10 can be bored by the electrical discharging. In this case, due to the formation effect of the flat sections 10c, a dispersion of spark energy can be reduced, thereby easily securing a high dimensional tolerance.

### Second Embodiment

As shown in FIG. 5, the group of injection holes 10 (the injection holes 10a, 10a) is provided at the boring portions thereof with flat sections 10d, and the flat sections 10d are provided with the group of injection holes 10.

The flat sections 10d form planar surfaces perpendicular to the axis lines of the bored injection holes 10a and can be easily formed by the machining such as the cutting or forging. The dimensional tolerance, such as relative positions/angles of the respective flat sections 10d, 10d . . . , can be secured with comparative ease by the machining process.

Thus, the processing accuracy can be improved by boring the injection holes 10a, 10a with a drilling hole processing on the flat sections 10d where the dimensional tolerance has been secured.

Incidentally, in the present embodiment, an example, in which the group of injection holes 10 (the injection holes 10a, 10a) is bored with the machining (e.g., the drilling hole processing), on the respective flat sections 10d, 10d . . . , is provided without limitation, but as is the case with the first embodiment, the group of injection holes 10 can be bored by the electrical discharging.

In the present embodiment, an example of processing by the cutting and forging is shown as a machining method of the flat sections 10c, 10d, but the same effect can be expected by forming the flat sections on the boring portions of the injection holes, regardless of the machining method.

As mentioned above, the flat sections formed on the boring portions of the group of injection holes according to an embodiment of the present invention was described.

According to the foregoing explanation, in the method for boring the injection holes of the injector 1 having a plurality of intersections between the axis line of the injector 1 and the axes of the injection holes 10a bored in the injector 1, or so-called a group of injection holes, the boring potions of the injection holes 10a are formed on the flat sections 10c, 10d, which are perpendicular to the injection holes 10a and include the apertures of the injection holes 10a.

Accordingly, the processing tolerance of the injection holes can be decreased, and variations of the exhaust gas property can be reduced, thereby acquiring the stable performance.

The boring portions are provided with the recessed portions 10b and the recessed portions 10b are provided at the bottom thereof with the flat sections 10c.

Accordingly, the flat sections can be easily and accurately formed in the actual production processes.

The flat sections 10c, 10d are formed by cutting the boring portions. Accordingly, the flat sections can be easily and accurately formed in the actual production processes.

The flat sections 10c, 10d are formed by forging the boring portions. Accordingly, the flat sections can be easily and accurately formed in the actual production processes.

### INDUSTRIAL APPLICABILITY

The present invention can be widely available not only in the common-rail fuel injection device provided with the diesel engine but also in the fuel injection device where the injection holes for the fuel injection are formed.

1. A method for boring injection holes of an injector having a plurality of intersections between an axis line of an injector and the axes of the injection holes bored in the injector, comprising a step of:
forming flat sections, which are perpendicular to the injection holes and include apertures of the injection holes, on the boring portions of the injection holes.

2. The method for boring injection holes of the injector as set forth in claim 1, wherein the boring portions are provided with recessed portions and the recessed portions are provided at the bottom thereof with the flat sections.

3. The method for boring injection holes of the injector as set forth in claim 1, wherein the flat sections are formed by cutting the boring portions.

4. The method for boring injection holes of the injector as set forth in claim 1, wherein the flat sections are formed by forging the boring portions.

5. The method for boring injection holes of the injector as set forth in claim 2, wherein the flat sections are formed by cutting the boring portions.

6. The method for boring injection holes of the injector as set forth in claim 2, wherein the flat sections are formed by forging the boring portions.
